(19) United States
(12) Patent Application Publication
(10) Pub. No.: US 2012/0230014 A1
(43) Pub. Date: Sep. 13, 2012

(54) Fireplace with Lighting and Heating Arrangement

(76) Inventors: Ross Morrison, Faribault, MN (US); Robert Sloan, Prior Lake, MN (US); Gary Butler, Silver Lake, MN (US); Richard Donald Berg, Lakeville, MN (US)

(21) Appl. No.: 13/416,544

(22) Filed: Mar. 9, 2012

Related U.S. Application Data
(60) Provisional application No. 61/451,170, filed on Mar. 10, 2011.

(51) Int. Cl. F24B 1/191; F21V 33/00

(52) U.S. Cl. 362/92; 126/512

(57) ABSTRACT

A fireplace assembly includes an outer enclosure and an inner enclosure partitioned into first and second compartments. The inner enclosure is positioned within the outer enclosure. A light source is arranged within one of the first compartment and the second compartment and at least one of a lighting element and a heating element is included. Light emitted from the light source is emitted into portions of the lighting element and heating element to luminate portions of the same positioned within the first chamber.

### BACKGROUND

Fireplaces are an efficient method for providing warmth and creating the appeal of a fire within a room. Fireplaces have become commonplace in today's building trades for both residential and commercial applications. Most new home construction designs include one or more fireplace units. Further, a significant number of remodeling projects are focused on fireplaces.

### DESCRIPTION OF THE DRAWINGS

FIG. 1 is a front view of an example fireplace assembly.

FIG. 2 is a cross-sectional view of the fireplace assembly of FIG. 1.

FIG. 3 is a front view of a first example fireplace insert.

FIG. 4 is a side view of the insert of FIG. 3.

FIG. 5 is a top view of the insert of FIG. 3.

FIG. 6 is a side view of a panel of the insert of FIG. 3.

FIG. 7 is a perspective view of a second example fireplace insert including a first example heating and lighting arrangement.

FIG. 8 is a front view of the insert of FIG. 7.

FIG. 9 is a side view of the insert of FIG. 7.

FIG. 10 is a top view of the insert of FIG. 7.

FIG. 11 is a perspective view of the insert of FIG. 7 including a second example heating and lighting arrangement.

FIG. 12 is a front view of the insert of FIG. 11.

FIG. 13 is a side view of the insert of FIG. 12.

FIG. 14 is a top view of the insert of FIG. 13.

FIG. 15 is a perspective view of a cylindrical gas burner incorporated within the heating and lighting arrangement of FIG. 11.

### DETAILED DESCRIPTION

The present disclosure is directed towards a lighting and heating arrangement for an appliance such as a fireplace. Although not so limited, an appreciation of the various aspects of the disclosure will be gained through a discussion of the examples provided below.

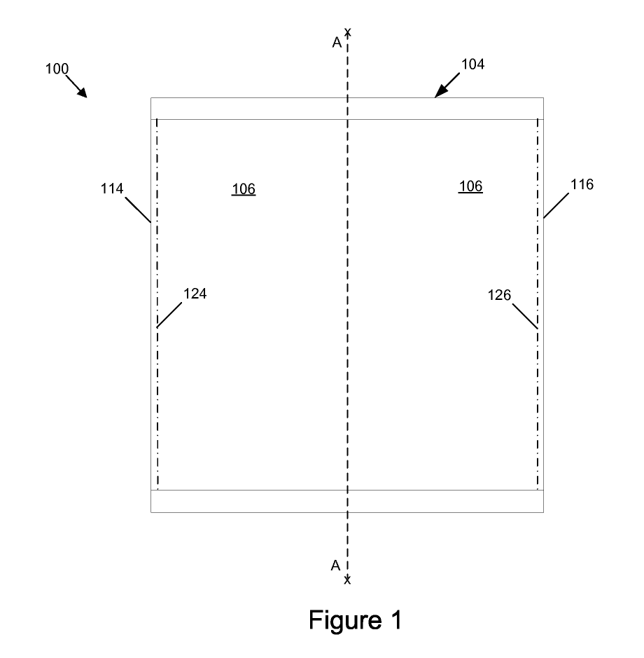

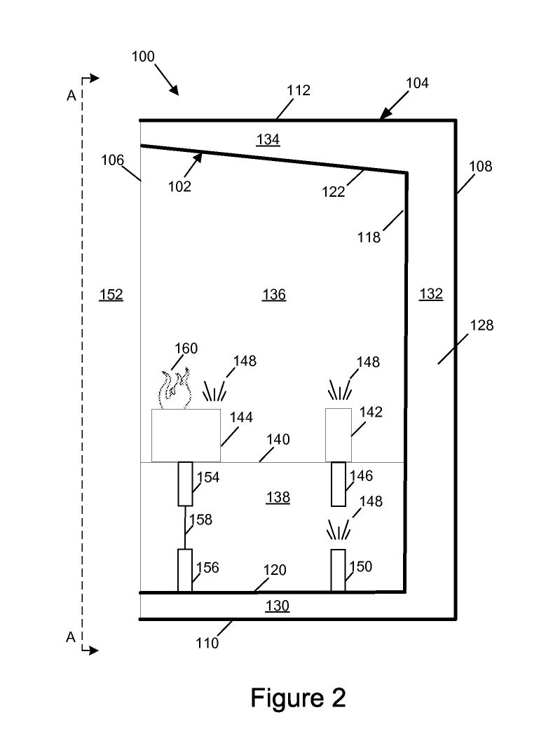

Referring to FIGS. 1 and 2, an example fireplace assembly 100 is shown. FIG. 1 is a front view of the fireplace assembly 100. FIG. 2 is a cross-sectional view of the fireplace assembly 100 taken along cross-section A-A as shown in FIG. 1.

The fireplace assembly 100 includes a removable insert 102 or enclosure positioned within an outer enclosure 104. The outer enclosure 104 is defined by a front panel 106, an outer rear panel 108, an outer bottom panel 110, an outer top panel 112, and outer side panels 114, 116. Similarly, the insert 102 is defined by an inner rear panel 118, an inner bottom panel 120, an inner top panel 122, and inner side panels 124, 126 (depicted as intermittent lines in FIG. 1). Other embodiments are possible. For example, in some embodiments, the insert 102 and the outer enclosure 104 are integrally formed as single unit. Additionally, both the insert 102 and the outer enclosure 104 can include more or fewer panels as desired.

The front panel 106 can include, for example, a translucent or transparent material, such as glass, ceramic, or plastic, to allow viewing of structures within the insert 102. In other embodiments, the front panel 106 can be a thermally transformable front wall that converts from opaque to less opaque upon heating. In yet other embodiments, the front panel 106 can include one or more openings and/or doors that allow viewing of structures in insert 102. Still other embodiments are possible.

The insert 102 and/or the outer enclosure 104 can include, for example, one or more respective panels formed of metal. In other embodiments, one or more of the respective panels of the insert 102 and/or the outer enclosure 104 can be formed of a polymeric material or a foam material such as, for example, medium density fiber construction foam. Still other embodiments are possible.

In the example shown, the fireplace assembly 100 is a gas fireplace. Examples of a gas fireplace include a natural vent gas fireplace, a direct vent gas fireplace, and a vent free gas fireplace. Depending on type, the fireplace assembly 100 may include a plenum system 128 with plenums 130, 132, 134 defined between the outer enclosure 104 and the insert 102 including appropriate components configured to properly implement heated air (re)circulation and/or venting of combustion by-products. Other embodiments are possible. For example, in some embodiments, the plenum system 128 is incorporated within the insert 102.

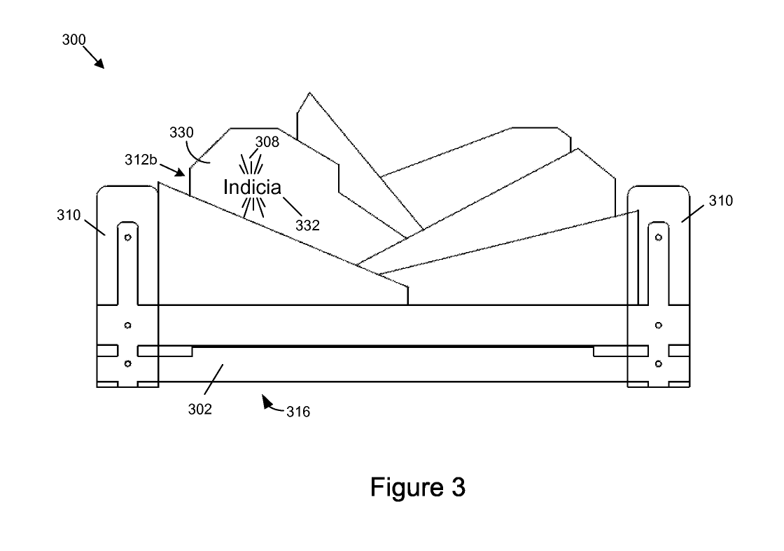

The insert 102 is partitioned into a first chamber 136 and a second chamber 138 separated by a floor 140. Portions of an illumination module 142 and portions of a heating module 144 are arranged in both the first chamber 136 and the second chamber 138. Example embodiments of illumination and heating arrangements configured similar to the illumination module 142 and the heating module 144 are described below in connection with FIGS. 3-15.

Referring specifically to FIG. 2, the illumination module 142 includes an extension 146 projecting through the floor 140 into the second chamber 138. The extension 146 is configured to secure the illumination module 142 to the floor 140. The extension 146 is additionally configured to guide at least a fraction of light 148 emitted from a light source 150 to the illumination module 142 for emission into the first chamber 136 to simulate glowing embers or logs of a fire, and/or other visual effects. In practice, a control assembly (not shown) is coupled to the light source 150 for the purpose of controlling various functionality of the light source 150 such as, for example, enable/disable, wavelength of emitted light, pulsation, etc. In this manner, the illumination module 142 is generally configured to provide aesthetically pleasing ambient lighting viewable from a space 152 external the fireplace assembly 100.

The heating module 144 is configured to provide or generate heat for heating the space 152 external the fireplace assembly 100. The heating module 144 includes a portion 154 extending through the floor 140 into the second chamber 138. The portion 154 is configured to secure the heating module 144 to the floor 140. The portion 154 is additionally configured to couple a fuel source 156 to the heating module 144 via a fuel line 158 for the purpose of generating a flame 160 within the first chamber 136. In practice, a valve assembly (not shown) is coupled to the fuel source 156 for the purpose of controlling characteristics of the flame 160 such as, for example, enable/disable, intensity, etc.

In some embodiments, the heating module 144 is additionally configured to provide ambient lighting viewable from the space 152 external the fireplace assembly 100, similar to the illumination module 142. In the example embodiment, the portion 154 is additionally configured to guide at least a fraction of the light 148 emitted from the light source 150 to the heating module 144 for emission into the first chamber 136 to simulate glowing embers or logs of a fire, and/or other visual effects. Other embodiments are possible. For example, in some embodiments, the portion 154 receives light from a dedicated light source (not shown) different than the light source 150. Still other embodiments are possible.

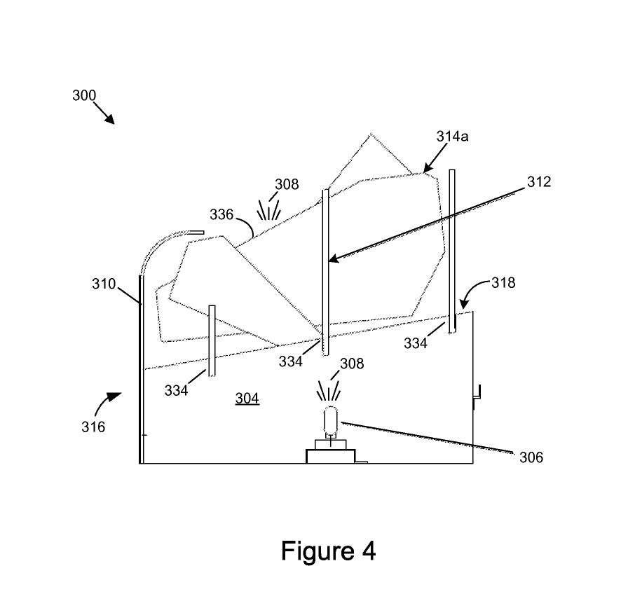

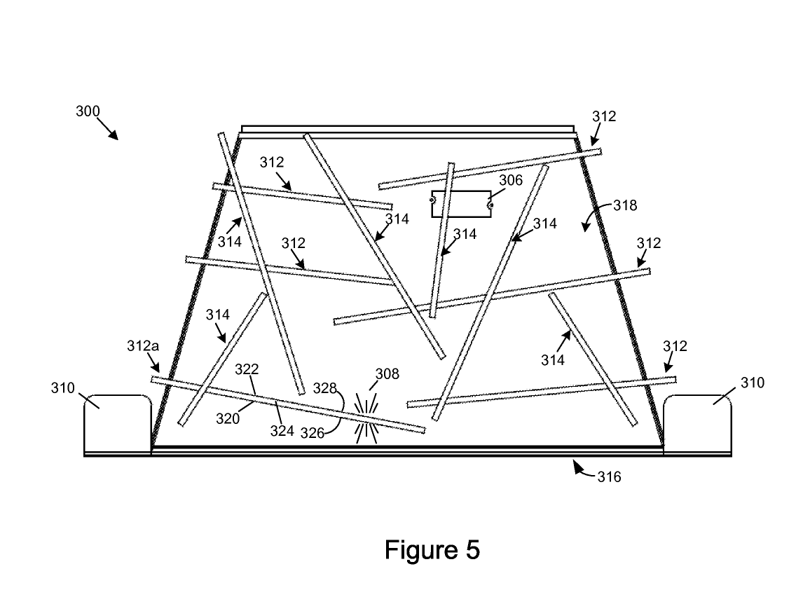

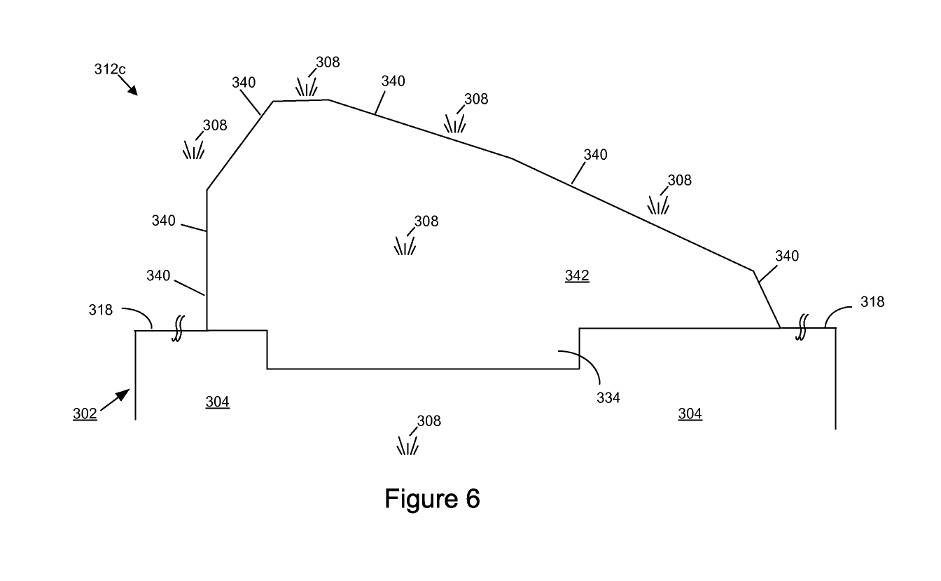

Referring to FIGS. 3-6, a first example fireplace insert 300 is shown in accordance with the principles of the present disclosure. FIG. 3 is a front view of the insert 300. FIG. 4 shows a side view of the insert 300. FIG. 5 shows a top view of the insert 300. FIG. 6 shows an enlarged side view of a panel of the insert 300.

The insert 300 includes a base 302 defining an internal compartment 304 that houses a light source 306 configured to emit light 308. The insert 300 also includes a plurality of andirons 310, a first plurality of panels 312, and a second plurality of panels 314. In example embodiments, the first and second plurality of panels 312, 314 are three-dimensional polygonal elements arranged in varying orientation with respect to each other. However, other embodiments are possible. For example, shape and orientation of the first and second plurality of panels 312, 314 can generally be selected as desired.

The first plurality of panels 312 are coupled to and at least partially secured within a top side 318 of the base 302. The second plurality of panels 314 are coupled to and secured with one or more of the first plurality of panels 312 in a stacked arrangement. In examples in which the panels 314 are stacked onto the panels 312, each of the panels 314 can include one or more grooves sized to receive a portion of the corresponding panel 312 to couple the panel 314 to the panel 312. Other configurations are possible.

In example embodiments, the first and second plurality of panels 312, 314 are formed of a material that: a) is at least partially transparent or translucent at visible wavelengths; and b) preferentially emits light at an edge and/or any imperfections located on a surface thereof. An example of such a material includes glass, quartz, ceramic, and others.

In general, an imperfection may be an intrinsic feature or an intentionally fashioned feature formed on a surface of the first and second plurality of panels 312, 314. An example of intrinsic feature includes an edge defining a transition between adjacent facets of a respective panel 312, 314. For example, FIG. 5 shows a first edge 320 and a second edge 322 defining a transition between a top facet 324 and side facets 326, 328 of a panel 312a. An example of an intentionally formed feature includes an etching formed within a facet of a respective panel 312, 314. For example, FIG. 3 shows a side facet 330 of a panel 312b including an etching “Indicia” 332. It will be appreciated that the etching “Indicia” 332 can be a custom feature including a marking held in admiration to an individual such as an owner of the insert 300. For example, the etching “Indicia” 332 may form a symbol(s) and/or a phrase(s) representing a favorite sporting franchise, hobby, product, etc. Other embodiments are possible.

In practice, a portion of the light 308 emitted from the light source 306 is transferred into the first plurality of panels 312 via respective integral tabs 334 positioned within the internal compartment 304 (e.g., FIG. 4). A first fraction of the light 308 transferred therein is emitted via any intrinsic or otherwise intentionally formed feature within each of the respective panels 312 with an intensity substantially greater than other panel portions. For example, the first and second edge 320, 322 of the panel 312a and the etching “Indicia” 332 of the panel 312b, as described in the above example, would emit the light 308 with an intensity greater than other portions of the respective panels 312a and 312b that are approximately featureless on the macroscale (i.e., approximately “smooth” facet faces).

A second fraction of the light 308 emitted into the first plurality of panels 312 is transferred into each of the second plurality of panels 314 that are coupled and secured thereto in the stacked arrangement. The second fraction of the light 308 is subsequently emitted via any intrinsic or otherwise intentionally formed feature within each of the respective panels 314 with an intensity substantially greater than other respective panel portions, similar to that described above. For example, FIG. 4 shows an edge 336 of a panel 314a emitting the light 308. It will be appreciated that the light 308 is emitted along an entire length along the panel 314a defined by the edge 336.

For example, referring to FIG. 6, a panel 312c is shown including an integrally formed tab 334 extending into the internal compartment 304 of the base 302 along a section of the top side 318 of the base 302. Light 308 emitted from the light source 306 (not shown) is emitted into the panel 312c via the tab 334, diffusing throughout and generally illuminating the entire panel 312c. Subsequently, light 308 impingent upon an edge 340 of the panel 312c is emitted at an intensity substantially greater than an illumination or apparent brightness of the panel 312c as viewed from other panel portions, such as a front facet 342 of the panel 312c. It will be appreciated that magnitude of illumination or apparent brightness of the panel 312c is dependent on bulk properties of the panel 312c, such a degree of opaqueness, and whether or not impurities within the panel 312c scatter light 308 diffusing therethrough.

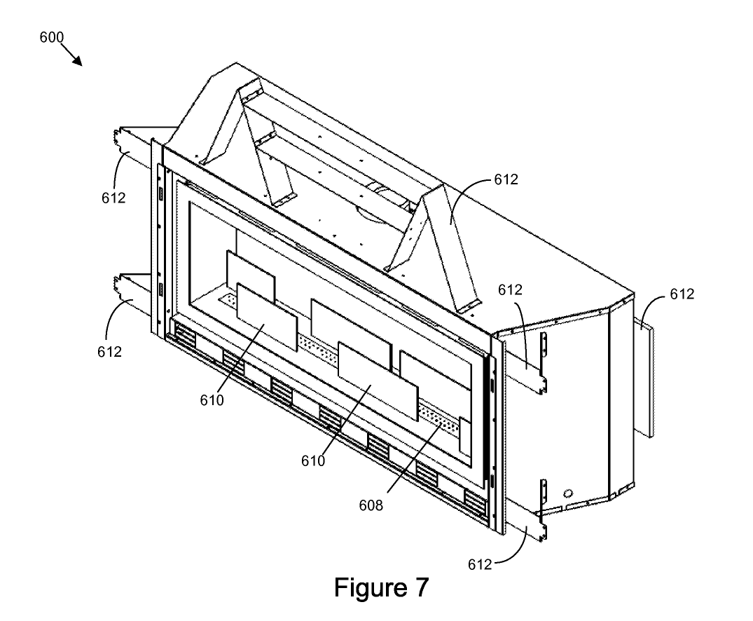

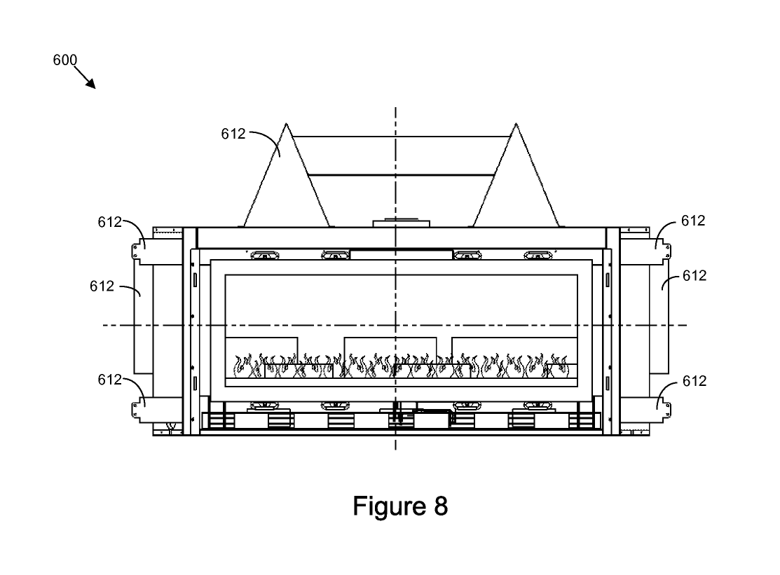

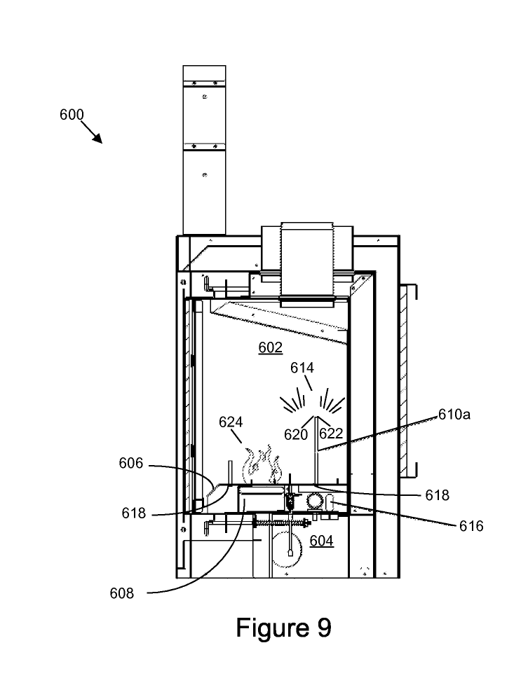

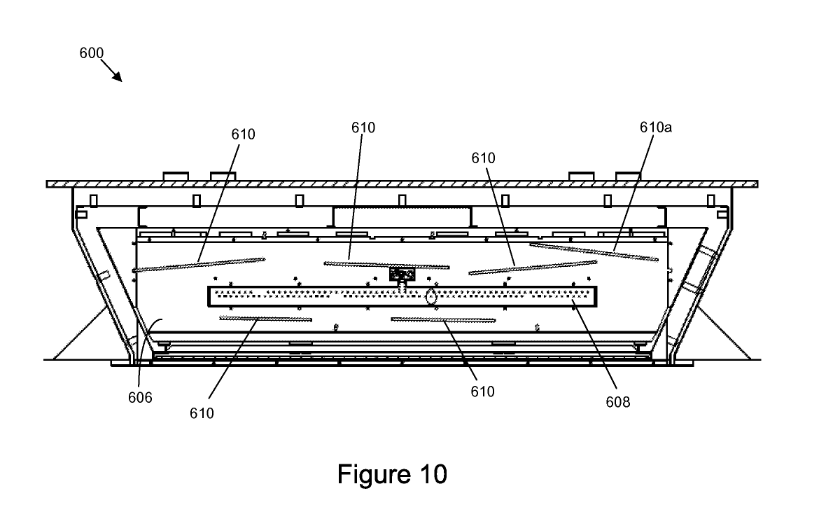

Referring to FIGS. 7-10, a second example fireplace insert 600 is shown including a first example lighting and heating arrangement in accordance with the principles of the present disclosure. FIG. 7 shows a perspective view of the insert 600. FIG. 8 shows a front view of the insert 600. FIG. 9 shows a side view of the insert 600. FIG. 10 shows a top view of the insert 600.

The insert 600 is partitioned into a first compartment 602 and a second compartment 604 separated by a panel 605. A gas burner 608 and a plurality of panels 610 both at least partially extend through a support base 606 and are positioned within the first compartment 602. A plurality of mounting flanges 612 are formed on the insert 600 for securing the insert 600 to an outer enclosure of a fireplace assembly (e.g., outer enclosure 104). Other embodiments are possible. For example, the shape and orientation of the plurality of panels 610 can generally be selected as desired.

In this example, combustion occurs in the first compartment 602. With the light 616 positioned within the first compartment 602, the light 616 is configured to withstand high temperatures. For example, the light 616 can be a halogen light. In other examples, the light 616 can be positioned outside the combustion chamber within the compartment 604. In such a configuration, one or more tabs (e.g., see tab 1004 described below) are configured to extend into the second compartment 604 to capture the light. In this example, different types of lights can be used because of the lower temperature, such as LED lights. Other configurations are possible.

In the example embodiment, the plurality of panels 610 are formed of a material that is at least partially transparent or translucent at visible wavelengths, and further preferentially emits light at imperfections located on a surface thereof, similar to the first and second plurality of panels 312, 314 described above.

In practice, a portion of light 614 emitted from a light source 616 arranged in the second compartment 604 is transferred into the plurality of panels 610 via respective tabs 618 positioned within the second compartment 604. At least a fraction of the light 614 transferred therein is subsequently emitted via any intrinsic or otherwise intentionally formed feature within each of the respective panels 610 with an intensity substantially greater than other panel portions, similar to that described above. For example, FIG. 9 shows light 614 emitted from edges 620, 622 of a panel 610a. Simultaneously, a flame 624 can be generated via the gas burner 608 and is visible (e.g., FIG. 8) through the plurality of panels 610 by virtue of the panels 610 being formed of a material that is at least partially transparent or translucent at visible wavelengths.

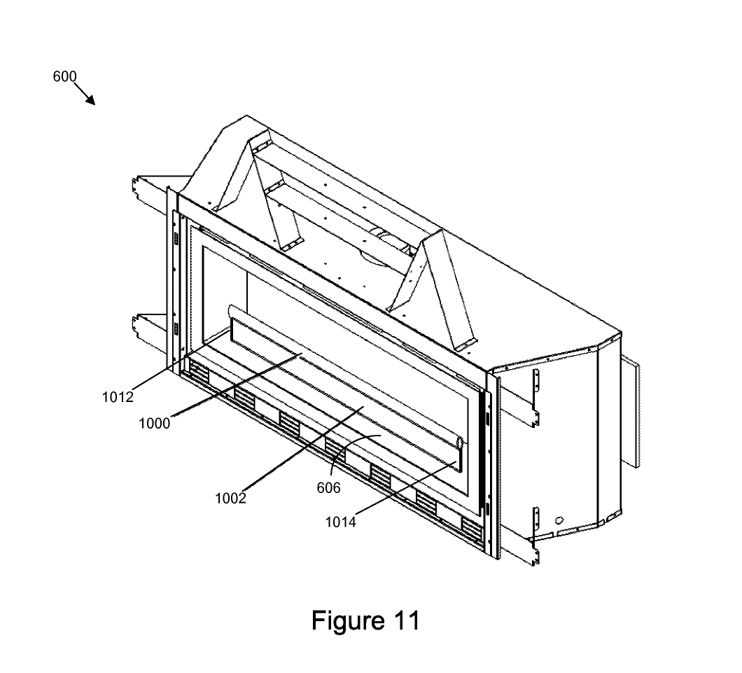

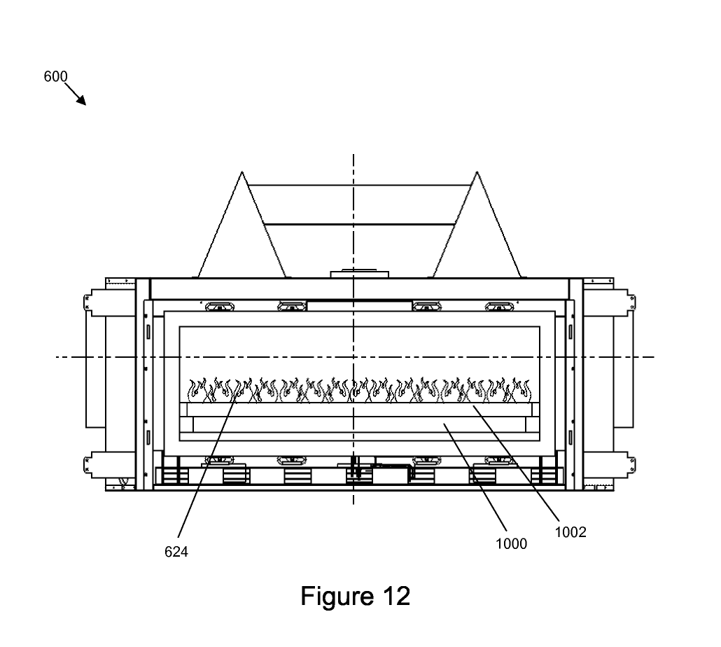

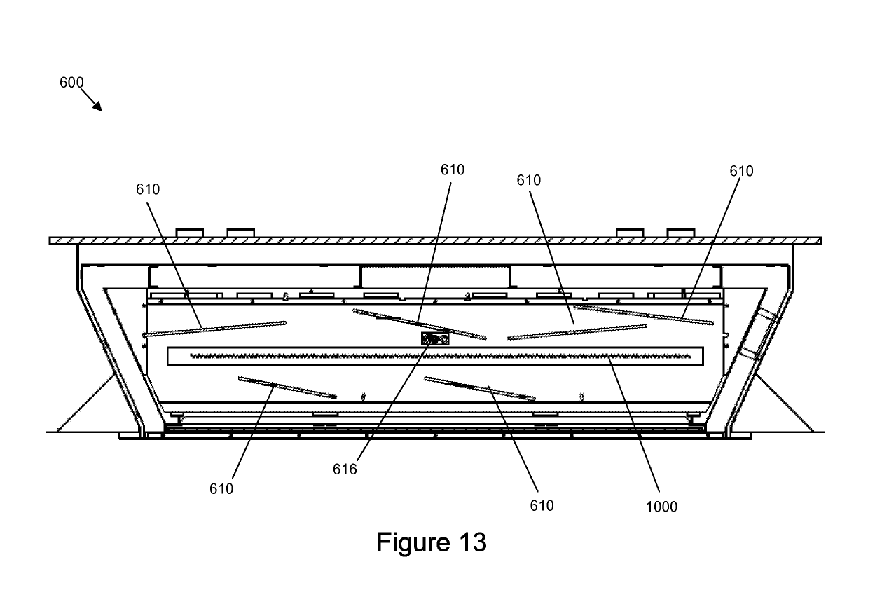

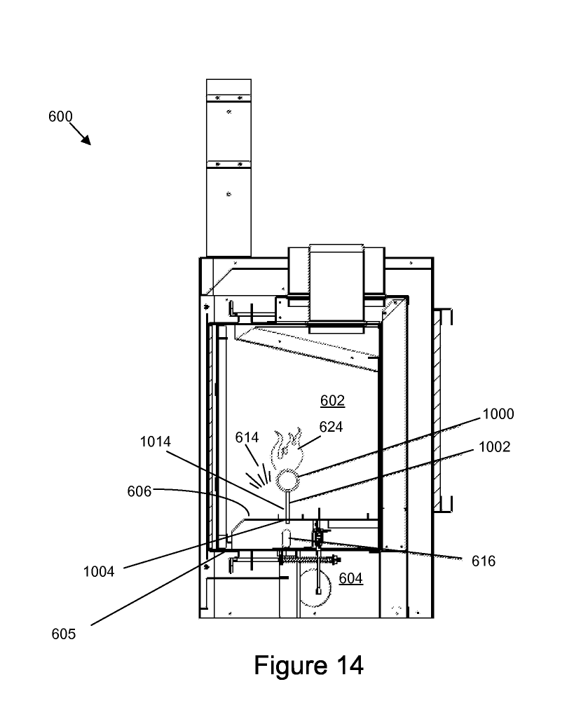

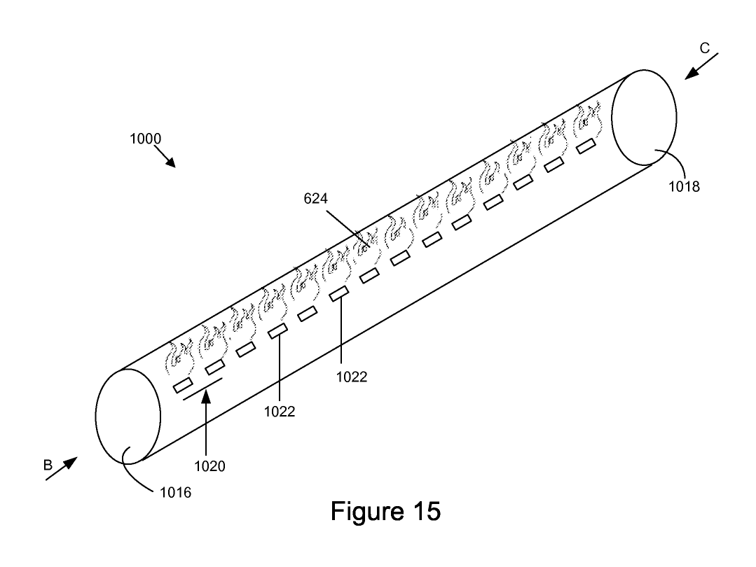

Referring to FIGS. 11-15, the second example fireplace insert 600 of FIGS. 6-10 is shown including a second example lighting and heating arrangement in accordance with the principles of the present disclosure. FIG. 11 shows a perspective view of the insert 600. FIG. 12 shows a front view of the insert 600. FIG. 13 shows a side view of the insert 600. FIG. 14 shows a top view of the insert 600. FIG. 15 shows a perspective view of an example gas burner of the second heating and lighting arrangement.

In example embodiments, a cylindrical gas burner 1000 is positioned adjacent to or in close proximity to a panel 1002 that extends through the support base 606. Additionally, a plurality of the panels 610 are optionally provided (e.g., FIG. 13), each partially extending through the support base 606. Other embodiments are possible. For example, the shape and orientation of the gas burner 1000 and panel 1002 can generally be selected as desired.

The gas burner 1000 and panel 1002 are formed of a material that is at least partially or fully transparent or translucent at visible wavelengths, and further preferentially emits light at imperfections located on a surface thereof, similar to the first and second plurality of panels 312, 314 described above. In some examples, the gas burner 1000 is formed of a semi-opaque or transparent material such as boro-silicate and quartz. Other possible materials include ceramic.

In practice, a portion of light 614 emitted from the light source 616 arranged in the second compartment 604 is transferred into the panel 1002 (and the plurality of panels 610) via a tab 1004 positioned within the second compartment 604. At least a fraction of the light 614 transferred therein is subsequently emitted via any intrinsic or otherwise intentionally formed feature within the panels 1002 with an intensity substantially greater than other panel portions, similar to that described above. For example, light 614 would be emitted from edges 1012, 1014 (e.g., FIGS. 11 and 14) of the panel 1002. Additionally, light 614 is transferred to the gas burner 1000 to luminate the gas burner 1000. Simultaneously, flame 624 can be generated via the gas burner 1000.

For example, FIG. 15 shows a perspective view of the gas burner 1000 including a first inlet 1016 and a second inlet 1018. In example embodiments, gas is forced into the first and second inlet 1016, 1018 in directions B, C at a predetermined flow rate. An ignition element 1020 is arranged to ignite gas exiting through each of a plurality of apertures 1022 to generate the flame 624. Other embodiments are possible. For example, shape and orientation of the ignition element 1020 and plurality of apertures 1022 can generally be selected as desired. Additionally, in some embodiments, the gas burner 1000 is formed to include only a single inlet (i.e., first inlet 1016 or second inlet 1018) such that the gas burner 1000 includes a single open end (e.g., first inlet 1016). Still other embodiments are possible.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A fireplace assembly, comprising:
an outer enclosure; and
an inner enclosure partitioned into a first and second chamber and positioned within the outer enclosure, wherein a light source is arranged within one of the first or the second chambers, and a plurality of lighting elements are partially positioned to capture light from the light source;
wherein each of the plurality of lighting elements are polygonal and are formed of a partially transparent material that preferentially emits light at imperfections located on a surface thereof, and light emitted from the light source is emitted into portions of the plurality of lighting elements that are positioned within the second chamber to luminate portions of the same positioned within the first chamber.

2. A fireplace assembly, comprising:
an outer enclosure; and
an inner enclosure partitioned into a first and second chamber and positioned within the outer enclosure, wherein a light source is arranged within one of the first or the second chamber, and a heating element including a transparent cylindrical gas burner is mounted to a panel partially positioned within the first chamber;
wherein light emitted from the light source is emitted into portions of the panel positioned within one of the first or the second chambers to luminate portions of the same and the cylindrical gas burner positioned within the first chamber.
